(19) United States
(12) Patent Application Publication
(10) Pub. No.: US 2014/0019178 A1
(43) Pub. Date: Jan. 16, 2014

(54) Brand Health Measurement - Investment Optimization Model

(71) Applicants: Natalie Kortum, Austin, TX (US); Rajiv Narang, Austin, TX (US); YingChi Chen, Austin, TX (US); George Sadler, Round Rock, TX (US); Brandon Vaughn, Leander, TX (US)

(72) Inventors: Natalie Kortum, Austin, TX (US); Rajiv Narang, Austin, TX (US); YingChi Chen, Austin, TX (US); George Sadler, Round Rock, TX (US); Brandon Vaughn, Leander, TX (US)

(21) Appl. No.: 13/547,322

(22) Filed: Jul. 12, 2012

(51) Int. Cl. G06Q 10/00

(52) U.S. Cl. 705/7.11

(57) ABSTRACT

A system and method are disclosed for optimizing brand equity return on investment (ROI). Original input data associated with a plurality of brand equity variables is processed using a brand equity ROI model to generate a first brand equity value, which in turn is processed to generate a dependent variable. Input data corresponding to an individual brand equity variable is then processed to generate changed input data, which in turn is processed by the brand equity ROI model with the original input data and the dependent variable to generate a second brand equity value. The first and second brand equity values are then processed to determine the effect of the changed data on the first brand equity value.

### BACKGROUND OF THE INVENTION

1. Field of the Invention

Embodiments of the invention relate generally to information handling systems. More specifically, embodiments of the invention provide a system and method for optimizing revenue through the inclusion of brand equity return on investment (ROI).

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Brand equity is a term that is commonly used to describe the value of having a brand name that is recognized and well-known. The underlying concept of brand equity is that products associated with a recognized or well-known brand name are likely to generate more revenue than products associated with a less recognized or well-known brand name. In part, this is due to the fact that consumers often believe that products associated with a well-known brand name are better than those associated with less well-known names. Brand equity is typically created through strategic investments in communication channels and market education. Generally, these strategic investments appreciate over time through economic growth in profit margins, market share, prestige value, and critical associations to deliver a return on investment (ROI), which is directly related to marketing ROI.

While brand equity is recognized as being strategically crucial, it is equally recognized as being difficult to quantify. Various approaches to analyzing brand equity are known, but there is no universally accepted way of measuring it. In part, this is due the fact that marketing professionals often find it difficult to reconcile the disconnect that exists between quantitative and qualitative values of brand equity. By way of explanation, quantitative brand equity includes numerical values such as profit margins and market share, but fails to capture qualitative elements such as prestige and associations of interest. Because of this challenge, many marketing practitioners have historically taken a more qualitative approach to brand equity.

A variety of elements can be included in the valuation of brand equity. These may include media mix modeling, key performance indicators (KPIs), net promoter score (NPS), and customer surveys. Other elements may include changing market share, profit margins, consumer recognition of logos and other visual elements, brand language associations made by consumers, consumers' perceptions of quality, and other relevant brand values. Analysis of the effect of these elements can be used to generate customer-facing metrics across the value chain spanning product design, to marketing, to delivery, and support as influencers on sales. In turn, these metrics can be used to statistically compute the relative importance of their respective contribution to sales. As such, these analyses could provide the basis for brand equity ROI measurement, planning and optimization. However, current approaches fail to take a holistic approach to assessing brand equity ROI. Instead, they generally focus on one aspect or another. Furthermore, quantitative approaches often vary over the same time period and it is difficult to know whether brand equity is increasing or decreasing. As a result, executives all too often revert to following their instincts when making decisions that will have an impact on cross functional groups or overall brand equity.

### SUMMARY OF THE INVENTION

A system and method are disclosed for optimizing overall revenue through the inclusion of brand equity return on investment (ROI). In various embodiments, input data associated with brand equity variables is received and cleansed, and lag values are solved for time series data. An initial brand equity ROI model is then built, using individual (e.g., Bayesian network), or combinations (e.g., combining Bayesian with structural equation models), of approaches. The resulting brand equity ROI model is then pruned to ensure that business sense is maintained, and the initial model is then run.

In one embodiment, the initial results from running the model are combined into latent variables, or alternatively, their individual variable impacts are simply summed, to produce functional optimizations. A current brand equity value is then generated, which in turn is used as a dependent variable in subsequent processes. In one embodiment, brand equity measurements are added to a “floating base” to determine the brand equity value. In this embodiment, the floating base is the equivalent of a constant in an equation. For example, in the equation y=ax+b, ‘b’ would be the floating base. In this and other embodiments, the brand equity value is accurate if all key business levers that impact revenue and brand are represented as input variables in the ROI model.

In various embodiments, the floating base, along with other measurements of brand equity such as Top 100 Brands, Net Promoter Score (NPS), survey results, and social media brand metrics are combined to form a new metric, referred to as brand equity. Modeling can then be performed where brand equity is the dependent variable and the same variables used in the revenue model are then applied. In these and other embodiments, the short-term and long-term impact of a given variable on brand can then be calculated. The short-term impact would be present in the revenue model and the long-term impact would be present in the brand equity model. Brand equity can be expressed in monetary form by the floating base amount. In various embodiments, similar structures are used for other business variables such as profit margin or sales leads.

In certain embodiments, a time series model approach is implemented with the aforementioned model to make it more predictive. In these and other embodiments, predetermined variables from the model are selected, each of which represents various functional levers. In turn, the time series model varies at least one variable from each functional lever. As a result, the time series model can show the impact of a given functional lever, such as sales, on revenue and brand equity in the future. In turn, the larger Bayesian network model can then be used to provide the details of the specific variables and Key Performance Indicators (KPIs) that merit improvement. In various embodiments, an independent brand equity variable is selected and the initial brand equity value is used as the dependent variable. The model is then run with varying values of the independent variable to determine its respective effect on revenue and brand equity value. The effect of these effects on revenue can then be quantified as inputs to a corresponding revenue model. The results of those subsequent runs can then be used to optimize individual business drivers to improve brand equity as well as overall revenue.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of the components of an information handling system as implemented in the system and method of the present invention;

FIG. 2 is a simplified network diagram showing the relationship between a plurality of brand equity input variables;

FIG. 3 is a simplified block diagram showing the analysis of brand equity input variables to generate brand equity metrics;

FIG. 4 is a simplified block diagram showing the causal relationship between a plurality of brand equity input variables and their resulting effect on brand equity;

FIG. 5 is a simplified bar chart showing the relative effect of a plurality of brand equity input variables on brand equity return on investment (ROI); and

FIG. 6 is a generalized flow chart of the performance of brand equity ROI operations.

### DETAILED DESCRIPTION

A system and method is disclosed for optimizing overall revenue through the inclusion of brand equity return on investment (ROI). For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

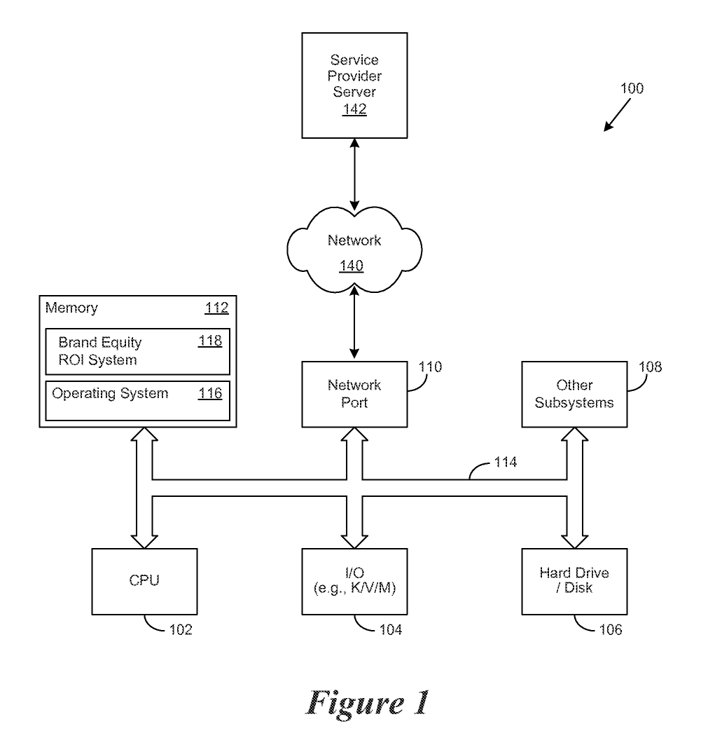

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which comprises operating system (OS) 116 and is interconnected to the foregoing via one or more buses 114. In various embodiments, the system memory 112 may also comprise a brand equity return on investment (ROI) system 118. In one embodiment, the information handling system 100 is able to download the brand equity ROI system 118 from the service provider server 142. In another embodiment, the brand equity ROI system 118 is provided as a service from the service provider server 142.

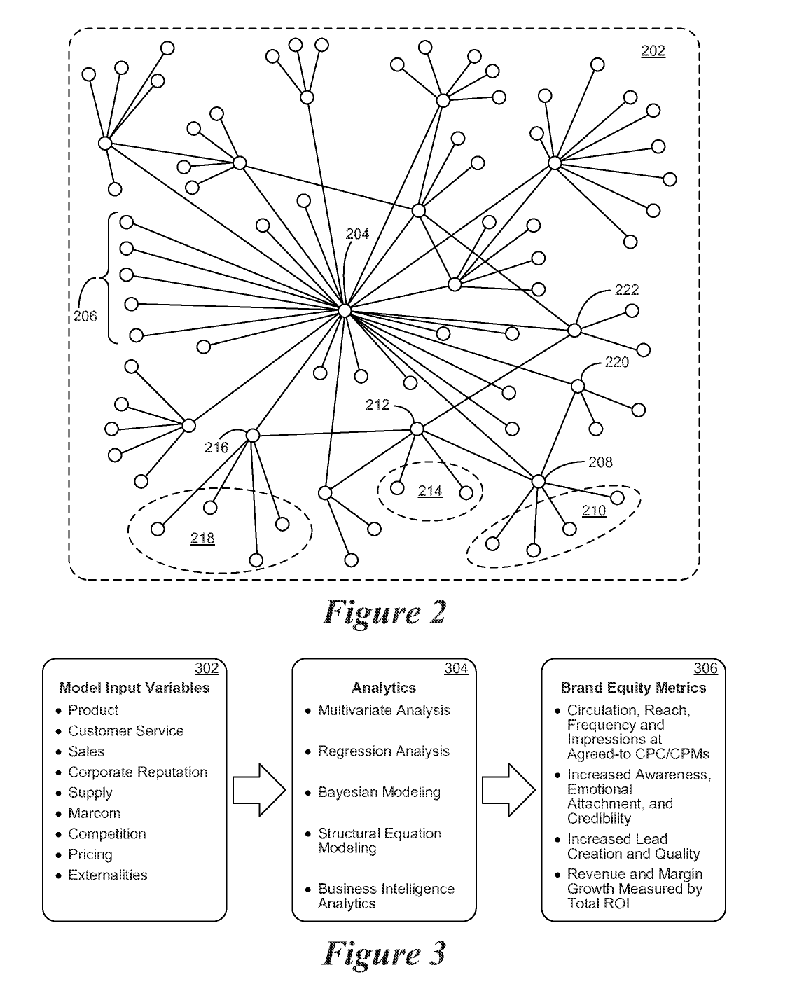

FIG. 2 is a simplified network diagram showing the relationship between a plurality of brand equity input variables implemented in accordance with an embodiment of the invention. In this embodiment, a plurality of brand equity variables 202 are implemented in a Bayesian network to provide brand equity input data to a brand equity ROI model 204. In various embodiments, the brand equity variables 202 may comprise individual 206 brand equity variables. In these and other embodiments, the brand equity variables 202 may likewise comprise aggregate 208, 212, 216 brand equity variables that respectively comprise related groups 210, 214, 218 of brand equity variables. In various embodiments, the brand equity variables 202 may likewise comprise correlated 208, 212, 216, 220 brand equity variables that are variously affected by their counterparts, which in turn affect the values they provide to the brand equity ROI model 204. It will be appreciated by those of skill in the art that many such embodiments are possible and the foregoing are provided only as examples and are not intended to limit the spirit, scope or intent of the invention.

FIG. 3 is a simplified block diagram showing the analysis of brand equity input variables implemented in accordance with an embodiment of the invention to generate brand equity metrics. As shown in FIG. 3, a plurality of model input variables 302 are analyzed using one or more analytic 304 methods to generate brand equity metrics 306. In various embodiments, the model input variables 302 may comprise brand equity variables related to product, customer service, sales, corporate reputation, supply, marketing communications (marcom), competition, pricing and externalities. In these and other embodiments, the product brand equity variable may further comprise data associated with product quality, patent recommendation submissions, online ratings, product breadth, market mix, marketing spend, awards and reviews. Likewise, the customer service brand equity variable may further comprise data associated with issue resolution rate, percentage of calls making it to a customer service representative in time, cost and rate of dissatisfaction, customer satisfaction survey results, and the percentage of delivered orders resulting in a call-back from the customer.

In certain embodiments, the sales brand equity variable may further comprise data associated with forecast attainment, sales operational expense (OPEX), sale team headcount, account transition rate, average number of accounts per sales representative, marketing seed investment, win and loss rate of sales leads, sales-ready leads, events budget and attendees, and revenue from consultancy services. Likewise, the corporate reputation brand equity variable may further comprise data associated with social media site visits and ‘fans’, net promoter score (NPS), green initiatives, brand tracking metrics, external surveys of vendor's brand equity, net tonality score (NTS) for public relations (PR), and social net advocacy (SNA) score.

In various embodiments, the supply brand equity variable may further comprise data associated with ship-to-commit (STC) accuracy, percentage of orders shipped before target date and the marcom brand equity variable may further comprise data associated with online total, email, shopping affiliates, online display, search, offline total, print, out-of-home (OOH), direct mail, marketing, and brand spend. Likewise, the competition brand equity variable may further comprise data associated with revenue compared to competitors, share of voice (SOV) in public relations (PR), SOV in marcom.

The pricing brand equity variable may likewise further comprise data associated with weighted average price position (WAPP), discount percentage—consumer vs. enterprise, net margin percentage—consumer vs. enterprise, stock keeping units (SKUs) on sale. Likewise, the externalities brand equity variable may further comprise data associated with gross domestic product (GDP), consumer price index (CPI), employment rate, inflation, interest rates, commodity channel index (CCI), seasonality, and industry analyst forecasts.

As likewise shown in FIG. 3, the one or more analytic 304 methods may comprise analytic 304 methods familiar to those of skill in the art, such as multivariate analysis, regression analysis, Bayesian modeling, structured equation modeling (SEM), and business intelligence (BI) analytics. In various embodiments, and as described in greater detail herein, these one or more analytic 304 methods may be implemented to generate a brand equity ROI model. Likewise, as shown in FIG. 3, the resulting brand equity metrics 306 generated from performing the aforementioned analytic 304 methods may comprise circulation, reach, frequency and impressions at agreed-upon cost-per-click (CPC) and cost-per-impression (CPM) promotion costs. The resulting brand equity metrics 306 may likewise comprise metrics associated with increased awareness, emotional attachment, credibility, increased lead generation, and quality. In various embodiments, the resulting brand equity metrics 306 may likewise comprise metrics associated with revenue and margin growth measured by total ROI.

In certain embodiments, revenue value is calculated as follows:

Revenue=β₀+β₁*Brand+β₂*Spend₁+β₃*Spend₂+β₄*X₁+β₅*X₂+β₆*X₃

where β₀ is the floating base

In these and other embodiments, brand value is calculated as follows:

Brand=β₇*Spend₁+β₃*Spend₂+β₉*X₁+β₁₀*X₂

In order to determine the optimum mix of spends, a new mix of spends (spend*) are used in the prior equation to generate a new brand value (Brand*) as follows:

Brand*=β₇*Spend*₁+β₈*Spend*₂+

The ratio by which the brand value has changed can then be determined as follows:

Change Ratio (CR)=(Brand*−Brand)/Brand

Since Brand Equity=β₀+β₁*Brand) and Brand contains β₀ as one of the variables, β₀ can be incremented by the same ratio that Brand changes. As a result:

Revenue*=(β₀+(β₀*CR))+β₁*Brand*+β₂*Spend*₁+β₃*Spend*₂+β₄*X₁+β₅*X₂+β₆*X₃

The function is then maximized to determine the optimum mix for a given budget.

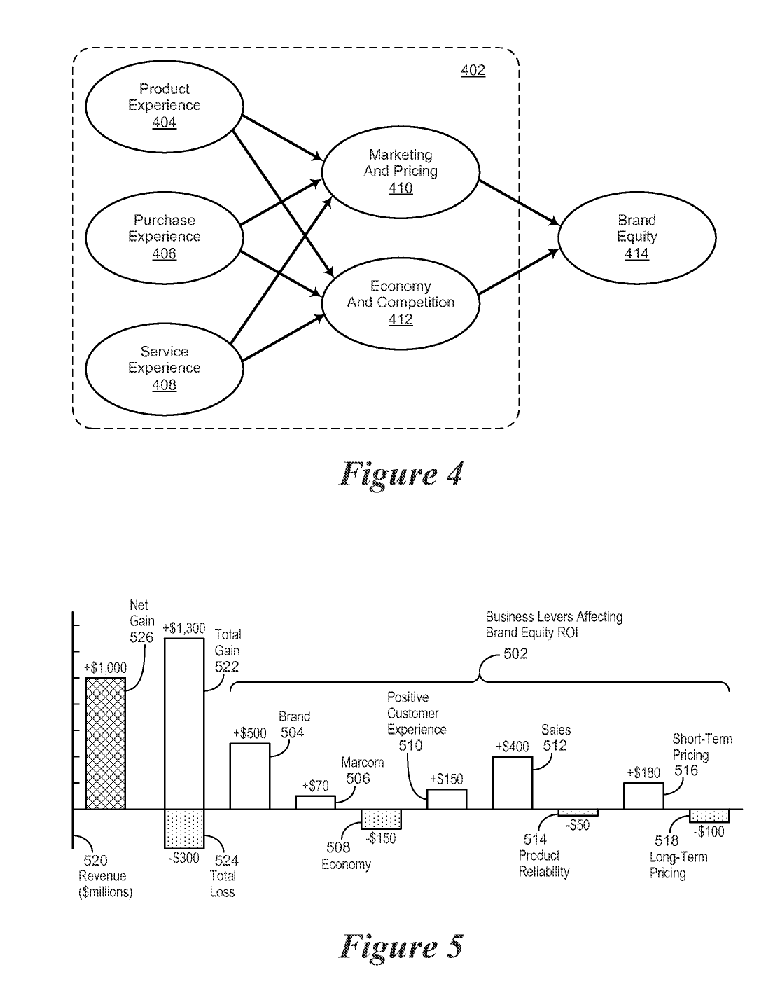

FIG. 4 is a simplified block diagram showing the causal relationship between a plurality of brand equity input variables implemented in accordance with an embodiment of the invention and their resulting effect on brand equity. As shown in FIG. 4, the brand equity variables 402, as described in greater detail herein, may comprise product experience 404, purchase experience 406, service experience 408, marketing and pricing 410, and economy and competition 412. In this embodiment, the causal relationship of the brand equity variables 402 between themselves and to brand equity 414 is expressed as a structural equation model (SEM) familiar to skilled practitioners of the art. These same skilled practitioners will recognize that the brand equity variables 402 may comprise other brand equity variables not shown and that the foregoing is not intended to limit the spirit, scope or intent of the invention.

As described in greater detail herein, various analytic methods (e.g., multivariate analysis, regression analysis, Basyesian modeling, SEM, business intelligence analytics, etc.) may be implemented individually or in combination to generate a brand equity 414 ROI model. In one embodiment, the various analytic methods comprises marketing mix modeling (MMM), which refers to the use of statistical analysis such as multivariate regressions on sales and marketing time series data to estimate the impact of various marketing tactics on sales and then forecast the impact of future sets of tactics. As such, it is often used to optimize advertising mix and promotional tactics with respect to sales revenue or profit.

Once the model is generated, the respective effect of various brand equity variables 402, either individually or by classes, groups or interrelationships, can be determined. As an example, it may be desirable to analyze and optimize the effect product has on brand equity 414 ROI. Accordingly, the values of various brand equity variables 402 are scaled back, leaving only the brand equity variables 402 that are most relevant to product. The granularity of the remaining brand equity variables 402 is then increased. As a result, the effect on brand equity 414 by varying the values of each of the remaining brand equity variables 402 can be seen in detail.

Those of skill in the art will appreciate that various instances of the brand equity 414 ROI model may require recalibration from time to time. For example, the effect one of the more granular brand equity variables 402 demonstrates a greater effect on brand equity 414 than others. As a result, this variable is included as an individual, or more highly valued, brand equity variable 402 in a higher-level brand equity 414 ROI model. In various embodiments, the more effective brand equity variable 402 is incorporated appropriately in other brand equity 414 ROI models as well.

Skilled practitioners of the art will be aware that Bayesian modeling does not lend itself to being predictive. Accordingly, in various embodiments predetermined key brand equity variables 402 are taken from a Bayesian brand equity 414 ROI model and are then included in a time series approach to make the brand equity 414 ROI model more predictive. In these and other embodiments, each functional group of brand equity variables 402 comprises at least one brand equity variable 402 that is represented in the time series. This approach provides the ability allows predictions to be made at a functional level. If additional details are required, then the Bayesian models can be analyzed to provide a plethora of details related to the various brand equity variables 402 in each respective Bayesian model. Those of skill in the art will recognize that the aforementioned approach is more limiting on the brand equity variables 402 that can be included in a brand equity 414 ROI model.

In one embodiment, more frequent results from the brand equity 414 ROI model are possible without having to relearn a source Bayesian network. In this and other embodiments, the input brand equity variables 402 are used with the existing network on a recurring basis. As the values of the input brand equity variables 402 change over time, resulting results and optimization details are provide, which in turn are used as guidance for course corrections on investment plans, campaign spend, etc. In another embodiment, the same brand equity input variables 402 are used, but they are revised to correspond to an industry-specific revenue to determine the relative impact of the brand equity input variables 402 within specific industry sectors.

In yet another embodiment, the time period for collecting measurement data associated with the brand equity input variables 402 is extended, with a corresponding decrease in the granularity of the brand equity input variables 402 associated with various aspects of marketing. In still another embodiment, the brand equity 414 ROI model is based upon a regression analysis model. In another embodiment, the brand equity 414 ROI model is based upon a regression analysis model is based upon a Bayesian model approach combined with a SEM model. In this and other embodiments, the aforementioned brand equity 414 ROI model is based upon a regression analysis model is used for validation. Those of skill in the art will realize that negative impacts resulting from the measurement data associated with the brand equity input variables 402 may have a negative influence on brand equity 414 ROI, which is acceptable.

In still another embodiment, the brand equity variables 402 comprise social media metrics. In this and other embodiments, the social media metrics are used to capture difficult-to-measure key performance indicators (KPIs), such as product innovation, and to provide an additional source for brand equity metrics that are more real-time in nature. In these various embodiments, it will be appreciated by skilled practitioners of the art that metrics associated with certain brand equity variables 402 may be more difficult to capture and using data from social media sources may be advantageous. As an example, it is possible that certain KPIs may be internally tweaked to make the performance of a line of business (LOB) appear successful, despite the fact that decisions are not being made for the right reasons. In such an example, social media metrics may provide improved measurements that are more reflective of the actual causes for the successful performance. From the foregoing, it will be appreciated that if social media metrics perform better than functional group KPIs, then a case can be made to either improve the KPIs or turn to social media measurements in lieu of the existing KPIS, as they are more heavily correlated with business impact.

FIG. 5 is a simplified bar chart showing the relative effect of a plurality of brand equity input variables, as implemented in accordance with an embodiment of the invention, on brand equity return on investment (ROI). In this embodiment, brand equity variables, as described in greater detail herein, are respectively adjusted to act as “business levers” 502 to determine their relative effect on brand equity ROI. As shown in FIG. 5, the business levers 502 being considered in this embodiment comprise “brand” 504, marketing communications (“marcom”) 506, “economy” 508, “positive customer experience” 510, “sales” 512, “product reliability” 514, “short-term pricing” 516, and “long-term pricing” 518. The resulting relative effect for predetermined values of the business levers 502 is then displayed in graphical form, along with a graphical representation of their effect upon revenue 520. As shown in FIG. 5, the resulting relative effect is displayed as “total gain” 522, “total loss” 524, and “net gain” 526. It will be appreciated that it is possible that the resulting relative effect will change as the value of each of the business levers 502 is changed. It will likewise be appreciated that applying various brand equity ROI models, as described in greater detail herein, allows for not only a full business view incorporating all business units, but also individual business units or lines of business by adjusting the business levers 502 that have an impact on revenue, brand equity, leads, etc.

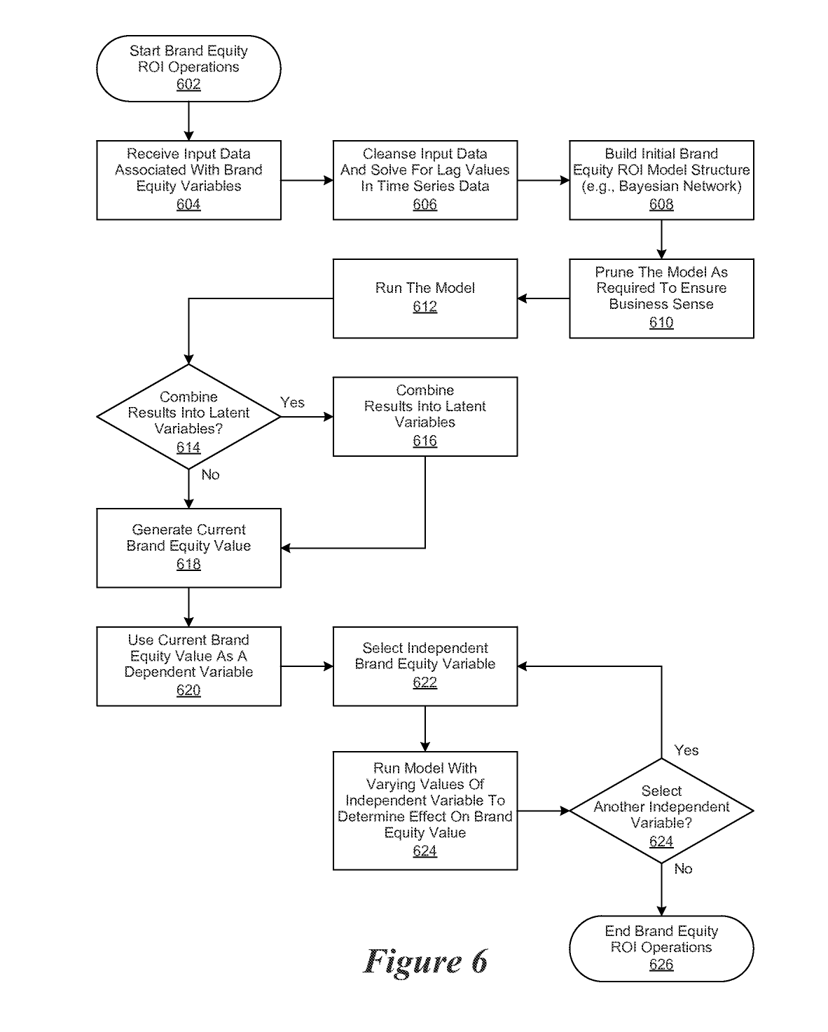

FIG. 6 is a generalized flow chart of the performance of brand equity return on investment (ROI) operations as implemented in accordance with an embodiment of the invention. In this embodiment, brand equity ROI operations are begun in step 602, followed by the receipt in step 604 of input data associated with brand equity variables described in greater detail herein. Then, in step 606, the input data is cleansed and lag values are solved for in time series data, using approaches familiar to those of skill in the art. An initial brand equity ROI model is then built in step 608, using individual (e.g., Bayesian network) or combinations (e.g., combining Bayesian with structural equation models) of approaches described in greater detail herein. The resulting brand equity ROI model is then pruned in step 610 to ensure that business sense is maintained, and the initial model is then run in step 612.

A determination is then made in step 614 whether to combine the initial results from running the model into latent variables, or alternatively, simply sum individual variable impacts, to produce functional optimizations. As an example, a product's revenue impact and elasticity, etc. is calculated by considering all variables associated with the products key performance indicators (KPIs) that are considered meaningful. If it is determined in step 614 to perform the combination or summation operations, then they are performed in step 616. Otherwise, or once the combination or summation operations are performed in step 616, then a current brand equity value is generated in step 618.

Then, in step 620, the resulting brand equity value is used as a dependent variable in the model in subsequent steps. In one embodiment, brand equity measurements are added to a “floating base” to determine the brand equity value. In this embodiment, the floating base is the equivalent of a constant in an equation. For example, in the equation y=ax+b, ‘b’ would be the floating base. In this and other embodiments, the brand equity value is accurate if all brand equity variables have been included as inputs to the brand equity ROI model. It will be appreciated that failure to include all relevant brand equity variables will likely result in an inaccurate brand equity value. As an example, failure to include all brand equity values that have an impact on revenue, then their actual impact is undefined and do not contribute to producing an accurate brand equity value. From the foregoing, it will be appreciated that the selection of brand equity variables is directly related to the brand equity ROI model producing meaningful and accurate results.

An independent brand equity variable is then selected in step 622, and the initial brand equity value is used as the dependent variable. The model is then run in step 624 with varying values of the independent variable to determine its respective effect on brand equity value. The effect of these effects on revenue can then be quantified as inputs to a corresponding revenue model. As an example, contribution percentages from the results of this run of the model can be applied to the brand equity variable “revenue value” in subsequent runs of the brand equity ROI model. The results of those subsequent runs can then be used to optimize individual business drivers to improve brand equity ROI. Those of skill in the art will recognize that the foregoing approach will assist in determining the long-term impact of a given brand equity variable on brand equity ROI. A determination is then made in step 624 whether to select another independent variable. If so, then the process is continued, proceeding with step 622. Otherwise, brand equity ROI operations are ended in step 626.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A computer-implementable method for optimizing brand equity return on investment (ROI), comprising:
receiving original input data associated with a plurality of brand equity variables;
processing the original input data to generate a first brand equity value, the input data processed by a brand equity ROI model;
processing the first brand equity value to generate a dependent variable;
changing input data corresponding to an individual brand equity variable of the plurality of brand equity variables to generate changed input data;
using the brand equity ROI model to process the original input data, the dependent variable, and the changed input data with to generate a second brand equity value; and
processing the first and second brand equity values to determine the effect of the changed data on the first brand equity value.

2. The method of claim 1, wherein the original input data comprises measurement data associated with at least one of:
a product;
customer service;
sales;
corporate reputation;
supply;
marketing communications;
competition;
pricing; and
externalities.

3. The method of claim 1, wherein an analytic method used by the brand equity ROI model comprises at least one of:
multivariate analysis;
regression analysis;
Bayesian modeling;
structural equation modeling (SEM); and
business intelligence analytics.

4. The method of claim 1, wherein the original input data is cleansed prior to being processed.

5. The method of claim 1, wherein:
the original input data comprises time series data further comprising lag values; and
the lag values are processed to solve the lag values prior to being processed.

6. The method of claim 1, wherein the brand equity ROI model is pruned prior to being processed to ensure business sense.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
receiving original input data associated with a plurality of brand equity variables;
processing the original input data to generate a first brand equity value, the input data processed by a brand equity ROI model;
processing the first brand equity value to generate a dependent variable;
changing input data corresponding to an individual brand equity variable of the plurality of brand equity variables to generate changed input data;
using the brand equity ROI model to process the original input data, the dependent variable, and the changed input data with to generate a second brand equity value; and
processing the first and second brand equity values to determine the 22 effect of the changed data on the first brand equity value.

8. The system of claim 7, wherein the original input data comprises measurement data associated with at least one of.
a product;
customer service;
sales;
corporate reputation;
supply;
marketing communications;
competition;
pricing; and
externalities.

9. The system of claim 7, wherein an analytic method used by the brand equity ROI model comprises at least one of:
multivariate analysis;
regression analysis;
Bayesian modeling;
structural equation modeling (SEM); and
business intelligence analytics.

10. The system of claim 7, wherein the original input data is cleansed prior to being processed.

11. The system of claim 7, wherein:
the original input data comprises time series data further comprising lag values; and
the lag values are processed to solve the lag values prior to being processed.

12. The system of claim 7, wherein the brand equity ROI model is pruned prior to being processed to ensure business sense.

13. A non-transitory, computer-readable storage medium embodying computer program code, the computer program code comprising computer executable instructions configured for:
receiving original input data associated with a plurality of brand equity variables;
processing the original input data to generate a first brand equity value, the input data processed by a brand equity ROI model;
processing the first brand equity value to generate a dependent variable;
changing input data corresponding to an individual brand equity variable of the plurality of brand equity variables to generate changed input data;
using the brand equity ROI model to process the original input data, the dependent variable, and the changed input data with to generate a second brand equity value; and
processing the first and second brand equity values to determine the effect of the changed data on the first brand equity value.

14. The non-transitory, computer-readable storage medium of claim 13, wherein the original input data comprises measurement data associated with at least one of:
a product;
customer service;
sales;
corporate reputation;
supply;
marketing communications;
competition;
pricing; and
externalities.

15. The non-transitory, computer-readable storage medium of claim 13, wherein an analytic method used by the brand equity ROI model comprises at least one of:
multivariate analysis;
regression analysis;
Bayesian modeling;
structural equation modeling (SEM); and
business intelligence analytics.

16. The non-transitory, computer-readable storage medium of claim 13, wherein the original input data is cleansed prior to being processed.

17. The non-transitory, computer-readable storage medium of claim 13, wherein:
the original input data comprises time series data further comprising lag values; and
the lag values are processed to solve the lag values prior to being processed.

18. The non-transitory, computer-readable storage medium of claim 13, wherein the brand equity ROI model is pruned prior to being processed to ensure business sense.
